(19) United States
(12) Patent Application Publication
(10) Pub. No.: US 2017/0317379 A1
(43) Pub. Date: Nov. 2, 2017

(54) LITHIUM-ION BATTERY

(71) Applicant: Hitachi Chemical Company, Ltd., Tokyo (JP)

(72) Inventors: Ryuichiro FUKUTA, Chiyoda-ku, Tokyo (JP); Katsunori KOJIMA, Chiyoda-ku, Tokyo (JP)

(21) Appl. No.: 15/522,225

(22) PCT Filed: Oct. 27, 2015
(86) PCT No.: PCT/JP2015/080272

§ 371 Date: Apr. 26, 2017

(30) Foreign Application Priority Data
Oct. 27, 2014 (JP) 2014-218156

(51) Int. Cl. H01M 10/0525; H01M 4/62; H01M 4/525; H01M 4/131; H01M 4/505; H01M 4/485; H01M 10/0568

(52) U.S. Cl. CPC H01M 10/0525; H01M 10/0568; H01M 4/625; H01M 4/622; H01M 4/131; H01M 4/505; H01M 4/485; H01M 4/525

(57) ABSTRACT

A lithium-ion battery includes: a positive electrode, a negative electrode, and an electrolyte solution; in which the positive electrode comprises a current collector, and a positive electrode material mixture that is placed on at least one side of the current collector, in which the positive electrode material mixture comprises a positive electrode conductive material, a lithium nickel manganese complex oxide as a positive electrode active material, and a resin having a structural unit derived from a nitrile group-containing monomer as a positive electrode binder, and in which n a density of the positive electrode material mixture is from 2.5 g/cm³ to 3.2 g/cm³.

### TECHNICAL FIELD

The present invention relates to a lithium-ion battery.

### BACKGROUND ART

A lithium-ion battery is a secondary battery having a high volumetric energy density, and is used as a power source for a portable device, such as a notebook computer, and a cell phone, utilizing such characteristics.

In recent years, as a power source for an electronic device, a power source for power storage, a power source for an electric car or the like for which a movement toward higher performance and downsizing is advancing, a lithium-ion battery having a high input-output characteristics, a high volumetric energy density and a longer operating life has drawn attention.

For example, a battery using a positive electrode active material with a spinel structure for a positive electrode, which has a lithium absorption-desorption potential of approximately from 4.7 to 4.8 V with respect to Li/Li⁺, and a spinel structure titanium oxide as a negative electrode active material for a negative electrode, which has a lithium absorption-desorption potential of approximately 1.5 V with respect to Li/Li⁺ is investigated in Japanese Patent No. 4196234. In the battery, a higher energy density of a battery is achieved by using a positive electrode active material exhibiting a high voltage in a charged state.

Further, since a voltage with respect to Li/Li⁺ in a charged state of a negative electrode may be made to approximately 1.5 V, the activity of lithium absorbed in a molecular structure in a charged state is low, and reduction of an electrolyte can be suppressed. Further, even when a solvent constituting an electrolyte solution and a supporting electrolyte salt are compounds containing oxygen, since a negative electrode active material is an oxide, formation of an oxide skin on a surface of an electrolyte by a reaction between them can be suppressed. It is conceivable that auto discharge of a battery may be suppressed accordingly.

### SUMMARY OF INVENTION

### Technical Problem

It is described in Japanese Patent No. 4196234 that a battery, for which an energy density is high, auto discharge is limited, and storage characteristics are superior, may be realized.

Meanwhile, with respect to a battery using a positive electrode active material with a spinel structure for a positive electrode, which has a lithium absorption-desorption potential of approximately from 4.7 V to 4.8 V with respect to Li/Li⁺, and a spinel structure titanium oxide as a negative electrode active material for a negative electrode, which has a lithium absorption-desorption potential of approximately 1.5 V with respect to Li/Li⁺, further improvement of volumetric energy density and input characteristic has been demanded.

The present invention was made in view of the circumstances, and the problem to be solved by the present invention is to provide a lithium-ion battery having high volumetric energy density and high input characteristic.

### Solution to Problem

Specific embodiments for achieving the object are as follows.

<1> A lithium-ion battery containing:

a positive electrode,

a negative electrode, and

an electrolyte solution;

in which the positive electrode contains a current collector, and a positive electrode material mixture that is placed on at least one side of the current collector,

in which the positive electrode material mixture contains a positive electrode conductive material, a lithium nickel manganese complex oxide as a positive electrode active material, and a resin having a structural unit derived from a nitrile group-containing monomer as a positive electrode binder, and

in which a density of the positive electrode material mixture is from 2.5 g/cm³ to 3.2 g/cm³.

<2> The lithium-ion battery according to <1>, in which the negative electrode contains a lithium titanium complex oxide as a negative electrode active material, and a negative electrode conductive material.
<3> The lithium-ion battery according to <2>, in which the lithium titanium complex oxide has a spinel structure.
<4> The lithium-ion battery according to <2> or <3>, in which a content of the lithium titanium complex oxide is from 70% by mass to 100% by mass with respect to a total amount of the negative electrode active material.
<5> The lithium-ion battery according to any one of <2> to <4>, in which the negative electrode conductive material includes acetylene black.
<6> The lithium-ion battery according to any one of <1> to <5>, in which the lithium nickel manganese complex oxide has a spinel structure.
<7> The lithium-ion battery according to <6>, in which the lithium nickel manganese complex oxide having a spinel structure is a compound represented by LiNi_{X}Mn_{2-X}O₄ (0.3<X<0.7).
<8> The lithium-ion battery according to any one of <1> to <7>, in which the electric potential of the lithium nickel manganese complex oxide in a charged state is from 4.5 V to 5 V with respect to Li/Li⁺.
<9> The lithium-ion battery according to any one of <1> to <8>, in which a BET specific surface area of the lithium nickel manganese complex oxide is less than 2.9 m²/g.
<10> The lithium-ion battery according to any one of <1> to <9>, in which a content of the lithium nickel manganese complex oxide is from 60% by mass to 100% by mass with respect to a total amount of the positive electrode active material.
<11> The lithium-ion battery according to any one of <1> to <10>, in which the positive electrode conductive material includes acetylene black.
<12> The lithium-ion battery according to any one of <1> to <11>, in which the positive electrode binder further has at least one selected from the group consisting of a structural unit derived from a monomer represented by the Formula (I), and a structural unit derived from a monomer represented by the Formula (II),

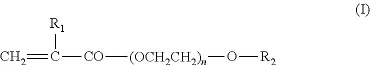

in which, in Formula (I), R₁ is H (hydrogen) or CH₃, R₂ is H (hydrogen) or a monovalent hydrocarbon group, and n is an integer of from 1 to 50,

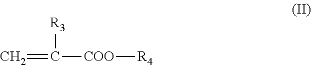

and in which, in Formula (II), R₃ is H (hydrogen) or CH₃, and R₄ is H (hydrogen) or an alkyl group having from 4 to 100 carbon atoms.

<13> The lithium-ion battery according to any one of <1> to <12>, in which the positive electrode binder further has a structural unit derived from a carboxyl group-containing monomer.
<14> The lithium-ion battery according to any one of <1> to <13>, in which the electrolyte solution contains an electrolyte and a nonaqueous solvent that dissolves the electrolyte, and the electrolyte includes lithium hexafluorophosphate.

### Advantageous Effects of Invention

According to the present invention, it is possible to provide a lithium-ion battery with a high volumetric energy density superior in input characteristic.

### BRIEF DESCRIPTION OF DRAWINGS

FIG. 1 is a perspective view showing an embodiment of a lithium-ion battery.

FIG. 2 is a perspective view showing a positive plate, a negative plate, and a separator constituting an electrode assembly.

### DESCRIPTION OF EMBODIMENTS

An embodiment of a lithium-ion battery in the invention will be described below.

In the present specification, each numerical range specified using “(from) . . . to . . . ” represents a range including the numerical values noted before and after “to” as the minimum value and the maximum value, respectively.

In the present specification, with respect to numerical ranges stated hierarchically herein, the upper limit or the lower limit of a numerical range of a hierarchical level may be replaced with the upper limit or the lower limit of a numerical range of another hierarchical level. Further, in the present specification, with respect to a numerical range, the upper limit or the lower limit of the numerical range may be replaced with a relevant value shown in any of Examples.

In referring herein to a content of a component in a composition, when plural kinds of substances exist corresponding to a component in the composition, the content means, unless otherwise specified, the total amount of the plural kinds of substances existing in the composition.

In referring herein to a particle diameter of a component in a composition, when plural kinds of particles exist corresponding to a component in the composition, the particle diameter means, unless otherwise specified, a value with respect to the mixture of the plural kinds of particles existing in the composition.

The term “layer” or “film” comprehends herein not only a case in which the layer or the film is formed over the whole observed region where the layer or the film is present, but also a case in which the layer or the film is formed only on part of the region.

The term “layered” as used herein indicates “provided on or above”, in which two or more layers may be bonded or detachable.

Regarding a lithium-ion battery in the present embodiment, a lithium nickel manganese complex oxide to be used as a positive electrode active material, a lithium titanium complex oxide to be used as a negative electrode active material, and the overall structure of a lithium-ion battery will be described below in the mentioned order.

<Positive Electrode Active Material>

According to the embodiment, a lithium nickel manganese complex oxide is used as a positive electrode active material.

A lithium nickel manganese complex oxide to be used as a positive electrode active material of a lithium-ion battery according to the embodiment is preferably a lithium nickel manganese complex oxide having a spinel structure. A lithium nickel manganese complex oxide having a spinel structure is a compound represented by LiNi_{X}Mn_{2-X}O₄ (0.3<X<0.7), more preferably a compound represented by LiNi_{X}Mn_{2-X}O₄ (0.4<X<0.6), and from the viewpoint of stability still more preferably LiNi_{0.5}Mn_{1.5}O₄. For stabilizing further the crystal structure of a lithium nickel manganese complex oxide having a spinel structure such as LiNi_{0.5}Mn_{1.5}O₄, a lithium nickel manganese complex oxide having a spinel structure, which Mn, Ni and/or O sites are partially substituted with another element such as a metal, may be used as a positive electrode active material.

Further, excessive lithium may be made present in a crystal of a lithium nickel manganese complex oxide having a spinel structure. Furthermore, a lithium nickel manganese complex oxide having a spinel structure, which O site is made to have a defect, may be used.

Examples of a metal element able to replace a Mn and/or a Ni site of a lithium nickel manganese complex oxide having a spinel structure include Ti, V, Cr, Fe, Co, Zn, Cu, W, Mg, Al, and Ru. A Mn and/or a Ni site of a lithium nickel manganese complex oxide having a spinel structure may be substituted with one kind, or two or more kinds of the metal elements. Among the substitutable metal elements, use of Ti as a substitutable metal is preferable from the viewpoint of further stabilization of the crystal structure of a lithium nickel manganese complex oxide having a spinel structure.

Examples of another substitutable element for an O site of a lithium nickel manganese complex oxide having a spinel structure include F and B. An O site of a lithium nickel manganese complex oxide having a spinel structure may be substituted with one, or two or more kinds of such other elements. Among such other substitutable elements, use of F is preferable from the viewpoint of further stabilization of the crystal structure of a lithium nickel manganese complex oxide having a spinel structure.

From the viewpoint of high volumetric energy density, the electric potential of the lithium nickel manganese complex oxide in a charged state with respect to Li/Li⁺ is preferably from 4.5 V to 5 V, and more preferably from 4.6 V to 4.9 V.

From the viewpoint of improvement of storage characteristics, a BET specific surface area of a lithium nickel manganese complex oxide is preferably less than 2.9 m²/g, more preferably less than 2.8 m²/g, still more preferably less than 1.5 m²/g, and further more preferably less than 0.3 m²/g. From the viewpoint of improvement of rate performance, the BET specific surface area of a lithium nickel manganese complex oxide is preferably 0.05 m²/g or more, more preferably 0.08 m²/g or more, and still more preferably 0.1 m²/g or more.

The BET specific surface area of a lithium nickel manganese complex oxide is preferably 0.05 m²/g or more and less than 2.9 m²/g, more preferably 0.05 m²/g or more and less than 2.8 m²/g, still more preferably 0.08 m²/g or more and less than 1.5 m²/g, and further more preferably 0.1 m²/g or more and less than 0.3 m²/g.

The BET specific surface area may be measured, for example, based on a nitrogen adsorption capacity according to JIS Z 8830:2013. Examples for a measuring apparatus include an AUTOSORB-1 (trade name) manufactured by Quantachrome Instruments. In measuring the BET specific surface area, moisture adsorbed on a surface of a sample or in the structure thereof may conceivably influence the gas adsorption capacity, and therefore a pretreatment for removing moisture by heating is preferably conducted firstly. In the pretreatment, a measurement cell loaded with 0.05 g of a measurement sample is evacuated by a vacuum pump to be 10 Pa or less, then heated at 110° C. for a duration of 3 hours or longer, and cooled naturally to normal temperature (25° C.) while maintaining the reduced pressure. After the pretreatment, the measurement temperature is lowered to 77K and a measurement is conducted in a measurement pressure range of less than 1 in terms of relative pressure which is namely an equilibrium pressure with respect to a saturated vapor pressure.

From the viewpoint of dispersibility of a mixture slurry, the median diameter D50 of a particle of a lithium nickel manganese complex oxide having a spinel structure (in a case in which primary particles aggregate to form a secondary particle, the median diameter D50 means the secondary particle) is preferably from 0.5 μm to 100 μm, and more preferably from 1 μm to 50 μm.

In this regard, a median diameter D50 may be determined from a particle size distribution obtained by a laser diffraction scattering method. Specifically, a lithium nickel manganese complex oxide is added into pure water at 1% by mass, and dispersed ultrasonically for 15 min, and then a measurement by a laser diffraction scattering method is performed.

A positive electrode active material in a lithium-ion battery according to the embodiment may include a positive electrode active material other than a lithium nickel manganese complex oxide (hereinafter occasionally also referred to as “another positive electrode active material”).

Examples of another positive electrode active material include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, and LiₓMn_{2-y}M_{y}O₄, in each Formula, M represents at least one element selected from the group consisting of Na, Mg, Sc, Y, Mn, Fe, Co, Cu, Zn, Al, Cr, Pb, Sb, V, and B. x is from 0 to 1.2, y is from 0 to 0.9, and z is from 2.0 to 2.3. In this case, an x value representing a molar ratio of lithium varies depending by charge and discharge.

When another positive electrode active material is included as a positive electrode active material, a BET specific surface area of such another positive electrode active material is, from the viewpoint of improvement of storage characteristics, preferably less than 2.9 m²/g, more preferably less than 2.8 m²/g, still more preferably less than 1.5 m²/g, and further more preferably less than 0.3 m²/g. From the viewpoint of improvement rate performance, the BET specific surface area is preferably 0.05 m²/g or more, more preferably 0.08 m²/g or more, and still more preferably 0.1 m²/g or more.

The BET specific surface area of such another positive electrode active material is preferably 0.05 m²/g or more and less than 2.9 m²/g, more preferably 0.05 m²/g or more and less than 2.8 m²/g, still more preferably 0.08 m²/g or more and less than 1.5 m²/g, and further more preferably 0.1 m²/g or more and less than 0.3 m²/g.

The BET specific surface area of such another positive electrode active material may be measured by a method similar to a lithium nickel manganese complex oxide having a spinel structure.

When another positive electrode active material is included as a positive electrode active material, the median diameter D50 of a particle of such another positive electrode active material (in a case in which primary particles aggregate to form a secondary particle, the median diameter D50 means the secondary particle) is, from the viewpoint of dispersibility of a mixture slurry, preferably from 0.5 μm to 100 μm, and more preferably from 1 μm to 50 μm. In this regard, a median diameter D50 of such another positive electrode active material may be measured by a method similar to that for a lithium nickel manganese complex oxide having a spinel structure.

From the viewpoint of improvement of battery capacity, a content (namely, a contained amount) of a lithium nickel manganese complex oxide is preferably from 60% by mass to 100% by mass with respect to a total amount of a positive electrode active material, more preferably from 70% by mass to 100% by mass, and still more preferably from 85% by mass to 100% by mass.

<Negative Electrode Active Material>

A lithium titanium complex oxide may be used as a negative electrode active material according to the embodiment.

A lithium titanium complex oxide to be used as a negative electrode active material of a lithium-ion battery according to the embodiment is preferably a lithium titanium complex oxide having a spinel structure. A basic compositional formula of a lithium titanium complex oxide having a spinel structure is represented by Li[Li_{1/3}Ti_{5/3}]O₄. For further stabilization of the crystal structure of a lithium titanium complex oxide having a spinel structure, part of Li, Ti, or O sites of a lithium titanium complex oxide having a spinel structure may be substituted with another element. Further, excessive lithium may be made present in a crystal of a lithium titanium complex oxide having a spinel structure. Furthermore, a lithium titanium complex oxide having a spinel structure, which 0 site is made to have a defect, may be used. Examples of a metal element able to replace a Li or Ti site of a lithium titanium complex oxide having a spinel structure include Nb, V, Mn, Ni, Cu, Co, Zn, Sn, Pb, Al, Mo, Ba, Sr, Ta, Mg, and Ca. A Li or Ti site of a lithium titanium complex oxide having a spinel structure may be substituted with one kind, or two or more kinds of these metal elements.

Examples of another element able to replace an O site of a lithium titanium complex oxide having a spinel structure include F and B. An O site of a lithium titanium complex oxide having a spinel structure may be substituted with one kind, or two or more kinds of such other elements. Among the substitutable elements, use of F is more preferable from the viewpoint of further stabilization of the crystal structure of a lithium titanium complex oxide having a spinel structure.

The electric potential of the lithium titanium complex oxide in a charged state is preferably from 1 V to 2 V with respect to Li/Li⁺.

From the viewpoint of improvement of storage characteristics, a BET specific surface area of a lithium titanium complex oxide having a spinel structure is preferably less than 2.9 m²/g, more preferably less than 2.8 m²/g, still more preferably less than 1.5 m²/g, and further more preferably less than 0.3 m²/g. From the viewpoint of improvement of rate performance, the BET specific surface area of a lithium titanium complex oxide having a spinel structure is preferably 0.05 m²/g or more, more preferably 0.08 m²/g or more, and still more preferably 0.1 m²/g or more. The BET specific surface area of a lithium titanium complex oxide having a spinel structure is preferably 0.05 m²/g or more and less than 2.9 m²/g, more preferably 0.05 m²/g or more and less than 2.8 m²/g, still more preferably 0.08 m²/g or more and less than 1.5 m²/g, and further more preferably 0.1 m²/g or more and less than 0.3 m²/g.

The BET specific surface area of a lithium titanium complex oxide having a spinel structure may be measured by a method similar to that for a lithium nickel manganese complex oxide having a spinel structure.

From the viewpoint of dispersibility of a mixture slurry, the median diameter D50 of a particle of a lithium titanium complex oxide having a spinel structure (in a case in which primary particles aggregate to form a secondary particle, the median diameter D50 means the secondary particle) is preferably from 0.5 μm to 100 μm, and more preferably from 1 μm to 50 μm.

A median diameter D50 of a lithium titanium complex oxide having a spinel structure may be measured by a method similar to that for a lithium nickel manganese complex oxide having a spinel structure.

A negative electrode active material in a lithium-ion battery according to the embodiment may include a negative electrode active material other than a lithium titanium complex oxide (hereinafter occasionally also referred to as “another negative electrode active material”).

Examples of another negative electrode active material include a carbon material.

From the viewpoint of safety and improvement of cycle performance, a content (namely, a contained amount) of a lithium titanium complex oxide is preferably from 70% by mass to 100% by mass with respect to the total amount of a negative electrode active material, more preferably from 80% by mass to 100% by mass, and still more preferably from 90% by mass to 100% by mass.

<Overall Structure of Lithium-Ion Battery>

A positive electrode of a lithium-ion battery is prepared by using a lithium nickel manganese complex oxide as a positive electrode active material, mixing therewith a conductive material and a positive electrode binder, if necessary adding an appropriate solvent to form a pasty positive electrode material mixture, and coating the pasty positive electrode material mixture onto a surface of a current collector made of a metallic foil such as an aluminum foil, followed by drying, and then, if necessary, by increasing the density of a positive electrode material mixture by pressing or the like. Thus, a positive electrode having a current collector, and a positive electrode material mixture placed on at least single side of the current collector is obtained. In this regard, a positive electrode active material may be composed solely of a lithium nickel manganese complex oxide, or a positive electrode active material may be also prepared by mixing a lithium complex oxide, such as LiCoO₂, LiNiO₂, LiMn₂O₄, LiFePO₄, and Li(Co_{1/3}Ni_{1/3}Mn_{1/3})O₂, with a lithium nickel manganese complex oxide for improving the characteristics of a lithium-ion battery.

In this regard, the “density of a positive electrode material mixture” means in the embodiment the density of a solid content contained in a positive electrode material mixture.

A negative electrode is prepared by using a lithium titanium complex oxide as a negative electrode active material, mixing therewith a conductive material and a negative electrode binder, if necessary adding an appropriate solvent to form a pasty negative electrode material mixture, and coating the pasty negative electrode material mixture onto a surface of a current collector made of a metallic foil such as a copper foil, followed by drying, and then, if necessary, by increasing the density of a negative electrode material mixture by pressing or the like. Thus, a negative electrode having a current collector, and a negative electrode material mixture placed on at least single side of the current collector is obtained. In this regard, a negative electrode active material may be composed solely of a lithium titanium complex oxide, or a negative electrode active material may be also prepared by mixing a carbon material or the like with a lithium titanium complex oxide for improving the characteristics of a lithium-ion battery.

In this regard, the “density of a negative electrode material mixture” means in the specification the density of a solid content contained in a negative electrode material mixture.

Since the electrical resistance of a positive electrode active material or a negative electrode active material is high, a conductive material is used for securing electrical conductivity of a positive electrode and a negative electrode, and for which carbon black such as acetylene black and Ketjenblack, and a powder of a carbon substance such as graphite may be used singly or in a combination of two or more kinds thereof. Further, the electroconductivity of a positive electrode and/or a negative electrode may be enhanced by adding carbon nanotube, graphene or the like as a conductive material.

As a conductive material used in a positive electrode (hereinafter occasionally also referred to as “positive electrode conductive material”), acetylene black is preferable from the viewpoint of improvement of rate performance.

Also as a conductive material used in a negative electrode (hereinafter occasionally also referred to as “negative electrode conductive material”), acetylene black is preferable from the viewpoint of improvement of rate performance.

Concerning a content (namely, a contained amount) of the positive electrode conductive material, a range of the content of the positive electrode conductive material with respect to a mass of a positive electrode material mixture is as follows. From the viewpoint of superior electrical conductivity, the lower limit of the range is preferably 2% by mass or more, more preferably 4% by mass or more, and still more preferably 5% by mass or more. From the viewpoint of improvement of battery capacity, the upper limit is preferably 20% by mass or less, more preferably 15% by mass or less, and still more preferably 10% by mass or less.

The range of the content of the positive electrode conductive material with respect to the mass of a positive electrode material mixture is preferably from 2% by mass to 20% by mass, more preferably from 4% by mass to 15% by mass, and still more preferably from 5% by mass to 10% by mass.

In another mode, the range of the content of the positive electrode conductive material with respect to the mass of a positive electrode material mixture is preferably from 1% by mass to 20% by mass, more preferably from 2% by mass to 15% by mass, and still more preferably from 3% by mass to 10% by mass.

Concerning a content (namely, a contained amount) of the negative electrode conductive material, a range of the content of the negative electrode conductive material with respect to a mass of the negative electrode material mixture is as follows. From the viewpoint of superior electrical conductivity, the lower limit of the range is preferably 0.01% by mass or more, more preferably 0.1% by mass or more, and still more preferably 1% by mass or more. From the viewpoint of improvement of battery capacity, the upper limit is preferably 45% by mass or less, more preferably 30% by mass or less, and still more preferably 15% by mass or less.

The content of the negative electrode conductive material with respect to the mass of a negative electrode material mixture is preferably from 0.01% by mass to 45% by mass, more preferably from 0.1% by mass to 30% by mass, and still more preferably from 1% by mass to 15% by mass.

A positive electrode binder is a resin having a structural unit derived from a nitrile group-containing monomer. When a positive electrode binder contains a resin having a structural unit derived from a nitrile group-containing monomer, the adherence between a positive electrode material mixture and a current collector is enhanced so that an input characteristic is improved.

From the viewpoint of improvement of flexibility and binding property, a positive electrode binder preferably further has at least one selected from the group consisting of a structural unit derived from a monomer represented by the Formula (I), and a structural unit derived from a monomer represented by the Formula (II) (in other words, a structural unit derived from a monomer represented by the Formula (I) and/or a structural unit derived from a monomer represented by the Formula (II)). Further, from the viewpoint of further improvement of binding property, a positive electrode binder preferably further has a structural unit derived from a carboxyl group-containing monomer.

A positive electrode binder more preferably has a structural unit derived from a nitrile group-containing monomer, a structural unit derived from a monomer represented by Formula (I), and a structural unit derived from a carboxyl group-containing monomer.

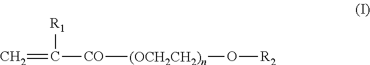

In which, in Formula (I), R₁ is H (hydrogen) or CH₃, R₂ is H (hydrogen) or a monovalent hydrocarbon group, and n is an integer of from 1 to 50.

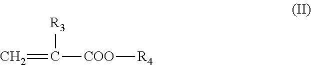

In which, in Formula (II), R₃ is H (hydrogen) or CH₃, R₄ is H (hydrogen) or an alkyl group having from 4 to 100 carbon atoms.

<Nitrile Group-Containing Monomer>

There is no particular restriction on a nitrile group-containing monomer according to the embodiment, and examples thereof include: an acrylic nitrile group-containing monomer such as acrylonitrile and methacrylonitrile; a cyanic nitrile group-containing monomer such as α-cyanoacrylate and dicyanovinylidene; and a fumaric nitrile group-containing monomer such as fumaronitrile. Among them, acrylonitrile is preferable from the viewpoint of easiness in polymerization, cost performance, softness and flexibility of an electrode. The nitrile group-containing monomers may be used singly or in a combination of two or more kinds thereof. When acrylonitrile and methacrylonitrile are used as a nitrile group-containing monomer according to the embodiment, acrylonitrile is contained for example in a range of from 5% by mass to 95% by mass with respect to the total amount of nitrile group-containing monomers, and preferably in a range of from 50% by mass to 95% by mass.

<Monomer Represented by Formula (I)>

There is no particular restriction on a monomer represented by Formula (I) according to the embodiment.

In Formula (I), R₁ is H or CH₃. n is an integer of from 1 to 50, preferably an integer of from 2 to 30, and more preferably an integer of from 2 to 10. R₂ is H (hydrogen) or a monovalent hydrocarbon group, preferably a monovalent hydrocarbon group having from 1 to 50 carbon atoms, more preferably a monovalent hydrocarbon group having from 1 to 25 carbon atoms, and still more preferably a monovalent hydrocarbon group having from 1 to 12 carbon atoms. When the carbon number of a monovalent hydrocarbon group is 50 or less, sufficient resistance to swelling by an electrolyte solution tends to be obtained. In this regard, examples of a hydrocarbon group include an alkyl group and a phenyl group. It is preferable that R₂ is especially an alkyl group having from 1 to 12 carbon atoms, and a phenyl group. The alkyl group may have a straight chain, or a branched chain. Further, at least part of hydrogens in an alkyl group or a phenyl group may be substituted with a halogen atom such as fluorine, chlorine, bromine and iodine, nitrogen, phosphorus, an aromatic ring, a cycloalkane having from 3 to 10 carbon atoms, or the like.

Specific examples of a commercially available monomer represented by Formula (I) include ethoxydiethylene glycol acrylate (trade name: LIGHT ACRYLATE EC-A, manufactured by Kyoeisha Chemical Co., Ltd.), methoxytriethylene glycol acrylate (trade name: LIGHT ACRYLATE MTG-A, manufactured by Kyoeisha Chemical Co., Ltd.; and trade name: NK ESTER AM-30G, manufactured by Shin-Nakamura Chemical Co., Ltd.), methoxy poly(n=9) ethylene glycol acrylate (trade name: LIGHT ACRYLATE 130-A, manufactured by Kyoeisha Chemical Co., Ltd.; and trade name: NK ESTER AM-90G, manufactured by Shin-Nakamura Chemical Co., Ltd.), methoxy poly(n=13) ethylene glycol acrylate (trade name: NK ESTER AM-130G, manufactured by Shin-Nakamura Chemical Co., Ltd.), methoxy poly(n=23) ethylene glycol acrylate (trade name: NK ESTER AM-230G, manufactured by Shin-Nakamura Chemical Co., Ltd.), octoxy poly(n=18) ethylene glycol acrylate (trade name: NK ESTER A-OC-18E, manufactured by Shin-Nakamura Chemical Co., Ltd.), phenoxydiethylene glycol acrylate (trade name: LIGHT ACRYLATE P-200A, manufactured by Kyoeisha Chemical Co., Ltd.; and trade name: NK ESTER AMP-20GY, manufactured by Shin-Nakamura Chemical Co., Ltd.), phenoxy poly(n=6) ethylene glycol acrylate (trade name: NK ESTER AMP-60G, manufactured by Shin-Nakamura Chemical Co., Ltd.), nonylphenol EO adduct(n=4) acrylate (trade name: LIGHT ACRYLATE NP-4EA, manufactured by Kyoeisha Chemical Co., Ltd.), nonylphenol EO adduct(n=8) acrylate (trade name: LIGHT ACRYLATE NP-BEA, manufactured by Kyoeisha Chemical Co., Ltd.), methoxydiethylene glycol methacrylate (trade name: LIGHT ESTER MC, manufactured by Kyoeisha Chemical Co., Ltd.; and trade name: NK ESTER M-20G, manufactured by Shin-Nakamura Chemical Co., Ltd.), methoxytriethylene glycol methacrylate (trade name: LIGHT ESTER MTG, manufactured by Kyoeisha Chemical Co., Ltd.), methoxy poly(n=9) ethylene glycol methacrylate (trade name: LIGHT ESTER 130MA, manufactured by Kyoeisha Chemical Co., Ltd.; and trade name: NK ESTER M-90G, manufactured by Shin-Nakamura Chemical Co., Ltd.), methoxy poly(n=23) ethylene glycol methacrylate (trade name: NK ESTER M-230G, manufactured by Shin-Nakamura Chemical Co., Ltd.), and methoxy poly(n=30) ethylene glycol methacrylate (trade name: LIGHT ESTER 041MA, manufactured by Kyoeisha Chemical Co., Ltd.). Among them, methoxytriethylene glycol acrylate (in Formula (I), R₁ is H, R₂ is CH₃, and n is 3) is more preferable from the viewpoint of copolymerization reactivity with acrylonitrile, or the like. The monomers represented by Formula (I) may be used singly or in a combination of two or more kinds thereof. In this regard, “EO” means ethylene oxide.

<Monomer Represented by Formula (II)>

There is no particular restriction on a monomer represented by Formula (II) according to the embodiment.

In Formula (II), R₃ is H, or CH₃. R₄ is H, or an alkyl group having from 4 to 100 carbon atoms, preferably an alkyl group having from 4 to 50 carbon atoms, more preferably an alkyl group having from 6 to 30 carbon atoms, still more preferably an alkyl group having from 8 to 15 carbon atoms. When the carbon number of an alkyl group is four or more, sufficient flexibility may be obtained. When the carbon number of an alkyl group is 100 or less, sufficient resistance to swelling by an electrolyte solution may be obtained. An alkyl group constituting R₄ may be a straight chain, or a branched chain. Further, at least part of hydrogens in an alkyl group constituting R₄ may be substituted with a halogen atom such as fluorine, chlorine, bromine and iodine, nitrogen, phosphorus, an aromatic ring, a cycloalkane having from 3 to 10 carbon atoms, or the like. Examples of an alkyl group constituting R₄ include saturated alkyl group of a straight chain or branched chain, as well as a halogenated alkyl group such as a fluoroalkyl group, a chloroalkyl group, a bromoalkyl group and an alkyl iodide group.

Specific examples of a monomer represented by Formula (II) include a long-chain (meth)acrylic acid ester such as n-butyl (meth)acrylate, isobutyl (meth)acrylate, t-butyl (meth)acrylate, amyl (meth)acrylate, isoamyl (meth)acrylate, hexyl (meth)acrylate, heptyl (meth)acrylate, octyl (meth)acrylate, 2-ethylhexyl (meth)acrylate, nonyl (meth)acrylate, decyl (meth)acrylate, isodecyl (meth)acrylate, lauryl (meth)acrylate, tridecyl (meth)acrylate, hexadecyl (meth)acrylate, stearyl (meth)acrylate, isostearyl (meth)acrylate, cyclohexyl (meth)acrylate, and isobornyl (meth)acrylate. Further, when R₄ is a fluoroalkyl group, examples of the monomer represented by Formula (II) include an acrylate compound such as 1,1-bis(trifluoromethyl)-2,2,2-trifluoroethyl acrylate, 2,2,3,3,4,4,4-heptafluorobutyl acrylate, 2,2,3,4,4,4-hexafluorobutyl acrylate, nonafluoroisobutyl acrylate, 2,2,3,3,4,4,5,5-octafluoropentyl acrylate, 2,2,3,3,4,4,5,5,5-nonafluoropentyl acrylate, 2,2,3,3,4,4,5,5,6,6,6-undecafluorohexyl acrylate, 2,2,3,3,4,4,5,5,6,6,7,7,8,8,8-pentadecafluorooctyl acrylate, 3,3,4,4,5,5,6,6,7,7,8,8,9,9,10,10,10-heptadecafluorodecyl acrylate, and 2,2,3,3,4,4,5,5,6,6,7,7,8,8,9,9,10,10,10-nonadecafluorodecyl acrylate; and a methacrylate compound such as nonafluoro-t-butyl methacrylate, 2,2,3,3,4,4,4-heptafluorobutyl methacrylate, 2,2,3,3,4,4,5,5-octafluoropentyl methacrylate, 2,2,3,3,4,4,5,5,6,6,7,7-dodecafluoroheptyl methacrylate, heptadecafluorooctyl methacrylate, 2,2,3,3,4,4,5,5,6,6,7,7,8,8,8-pentadecafluorooctyl methacrylate, and 2,2,3,3,4,4,5,5,6,6,7,7,8,8,9,9-hexadecafluorononyl methacrylate. The monomers represented by Formula (II) may be used singly or in a combination of two or more kinds thereof. In this regard, (meth)acrylate means acrylate, or methacrylate.

<Carboxyl Group-Containing Monomer>

There is no particular restriction on a carboxyl group-containing monomer according to the embodiment, and examples thereof include: an acrylic carboxyl group-containing monomer such as acrylic acid, and methacrylic acid; a crotonic carboxyl group-containing monomer such as crotonic acid; a maleic carboxyl group-containing monomer such as maleic acid and an anhydride thereof; an itaconic carboxyl group-containing monomer such as itaconic acid and an anhydride thereof; and a citraconic carboxyl group-containing monomer such as citraconic acid and an anhydride thereof. Among them, acrylic acid is preferable from the viewpoint of easiness of polymerization, cost performance, softness and flexibility of an electrode, or the like. The carboxyl group-containing monomers may be used singly or in a combination of two or more kinds thereof. When acrylic acid and methacrylic acid are used as a carboxyl group-containing monomer, acrylic acid is contained for example in a range of from 5% by mass to 95% by mass with respect to the total amount of carboxyl group-containing monomers, and preferably in a range of from 50% by mass to 95% by mass.

<Other Monomer>

A positive electrode binder according to the embodiment may also combine appropriately a structural unit derived from the nitrile group-containing monomer, a structural unit derived from a carboxyl group-containing monomer, at least one kind selected from the group consisting of a structural unit derived from a monomer represented by Formula (I), and a structural unit derived from a monomer represented by Formula (II), and additionally a structural unit derived from a monomer other than the monomers (hereinafter occasionally also referred to as “another monomer”). There is no particular restriction on such another monomer, and examples thereof include a short chain (meth)acrylic acid ester such as methyl (meth)acrylate, ethyl (meth)acrylate, and propyl (meth)acrylate, a halogenated vinyl such as vinyl chloride, vinyl bromide, and vinylidene chloride, maleic acid imide, phenylmaleimide, (meth)acrylamide, styrene, α-methylstyrene, vinyl acetate, sodium (meth)allyl sulfonate, sodium (meth)allyloxybenzene sulfonate, sodium styrene sulfonate, and 2-acrylamide-2-methylpropane sulfonic acid and a salt thereof. Such another monomers may be used singly or in a combination of two or more kinds thereof. In this regard, (meth)acrylic means acrylic or methacrylic. Further, (meth)allyl means allyl or methallyl.

<Content of Structural Unit Derived from Each Monomer>

When a positive electrode binder has in addition to a structural unit derived from a nitrile group-containing monomer, a structural unit derived from a carboxyl group-containing monomer, as well as at least one kind selected from the group consisting of a structural unit derived from a monomer represented by Formula (I), and a structural unit derived from a monomer represented by Formula (II), as for molar ratios among a structural unit derived from a nitrile group-containing monomer, a structural unit derived from a carboxyl group-containing monomer, and the total of a structural unit derived from a monomer represented by Formula (I) and a structural unit derived from a monomer represented by Formula (II), for example, with respect to 1 mol of a structural unit derived from a nitrile group-containing monomer, a structural unit derived from a carboxyl group-containing monomer is preferably from 0.01 mol to 0.2 mol, more preferably from 0.02 mol to 0.1 mol, and still more preferably 0.03 mol to 0.06 mol; and the total of a structural unit derived from a monomer represented by Formula (I) and a structural unit derived from a monomer represented by Formula (II) is preferably from preferably 0.001 mol to 0.2 mol, more preferably from 0.003 mol to 0.05 mol, and still more preferably from 0.005 mol to 0.02 mol. With respect to 1 mol of a structural unit derived from a nitrile group-containing monomer, it is preferable that a structural unit derived from a carboxyl group-containing monomer is from 0.01 mol to 0.2 mol, and the total of a structural unit derived from a monomer represented by Formula (I) and a structural unit derived from a monomer represented by Formula (II) is from 0.001 mol to 0.2 mol; more preferable that a structural unit derived from a carboxyl group-containing monomer is from 0.02 mol to 0.1 mol, and the total of a structural unit derived from a monomer represented by Formula (I) and a structural unit derived from a monomer represented by Formula (II) is from 0.003 mol to 0.05 mol; and further preferable that a structural unit derived from a carboxyl group-containing monomer is from 0.03 mol to 0.06 mol, and the total of a structural unit derived from a monomer represented by Formula (I) and a structural unit derived from a monomer represented by Formula (II) is from 0.005 mol to 0.02 mol. When a structural unit derived from a carboxyl group-containing monomer is from 0.01 mol to 0.2 mol, and the total of a structural unit derived from a monomer represented by Formula (I) and a structural unit derived from a monomer represented by Formula (II) is from 0.001 mol to 0.2 mol, the adhesiveness to a current collector, especially to a current collector using a copper foil, and the resistance to swelling by an electrolyte solution become excellent, and the softness and flexibility of electrode become favorable.

When a positive electrode binder has a structural unit derived from another monomer, its content with respect to 1 mol of a structural unit derived from a nitrile group-containing monomer is preferably from 0.005 mol to 0.1 mol, more preferably from 0.01 mol to 0.06 mol, and still more preferably from 0.03 mol 0.05 mol.

For a positive electrode binder, in addition to a resin having a structural unit derived from a nitrile group-containing monomer, the following binder may be mixed. Specific examples of the binder to be mixed include a resin-type polymer, such as polyethylene, polypropylene, polyethylene terephthalate, polymethyl methacrylate, polyimide, an aromatic polyamide, cellulose, and nitrocellulose; a rubber-type polymer, such as SBR (styrene-butadiene rubber), NBR (acrylonitrile-butadiene rubber), fluorocarbon rubber, isoprene rubber, butadiene rubber, and ethylene-propylene rubber; a thermoplastic elastomer-type polymer, such as a styrene-butadiene-styrene block copolymer or a hydrogenated product thereof, an EPDM (ethylene-propylene-diene terpolymer), a styrene-ethylene-butadiene-ethylene copolymer, a styrene-isoprene-styrene block copolymer or a hydrogenated product thereof; a soft resin-type polymer, such as a syndiotactic 1,2-polybutadiene, polyvinyl acetate, an ethylene-vinyl acetate copolymer, and a propylene-α olefin copolymer; a fluorinated polymer, such as polyvinylidene fluoride, polytetrafluoroethylene, a fluorinated polyvinylidene fluoride, a polytetrafluoroethylene-ethylene copolymer, and a polytetrafluoroethylene-vinylidene fluoride copolymer; and a composition of a polymer having ion conductivity of an alkali metal ion (especially lithium-ion). From the viewpoint of achievement of a higher density, mixture of polyvinylidene fluoride is preferably used.

A content (namely, a contained amount) of a positive electrode binder with respect to the mass of the positive electrode material mixture may be in the following range. The lower limit of the range is preferably 0.1% by mass or more from the viewpoint of adequate binding of a positive electrode active material to obtain an adequate mechanical strength of a positive electrode to stabilize battery performances such as cycle performance, more preferably 0.5% by mass or more, and still more preferably 1% by mass or more. The upper limit is preferably 40% by mass or less from the viewpoint of improvement of battery capacity and electrical conductivity, more preferably 25% by mass or less, and still more preferably 15% by mass or less.

The content of the positive electrode binder with respect to the mass of the positive electrode material mixture is preferably from 0.1% by mass to 40% by mass, more preferably from 0.5% by mass to 25% by mass, and still more preferably from 1% by mass to 15% by mass.

There is no particular restriction on a negative electrode binder, and a material superior in solubility or dispersibility in a dispersing solvent is selected. Specific examples thereof include a resin-type polymer, such as polyethylene, polypropylene, polyethylene terephthalate, polymethyl methacrylate, polyimide, an aromatic polyamide, cellulose, and nitrocellulose; a rubber-type polymer, such as SBR (namely, styrene-butadiene rubber), NBR (namely, acrylonitrile-butadiene rubber), fluorocarbon rubber, isoprene rubber, butadiene rubber, and ethylene-propylene rubber; a thermoplastic elastomer-type polymer, such as a styrene-butadiene-styrene block copolymer or a hydrogenated product thereof, an EPDM (namely, ethylene-propylene-diene terpolymer), a styrene-ethylene-butadiene-ethylene copolymer, a styrene-isoprene-styrene block copolymer or a hydrogenated product thereof; a soft resin-type polymer, such as a syndiotactic 1,2-polybutadiene, polyvinyl acetate, an ethylene-vinyl acetate copolymer, and a propylene-α olefin copolymer; a fluorinated polymer, such as polyvinylidene fluoride, polytetrafluoroethylene, a fluorinated polyvinylidene fluoride, a polytetrafluoroethylene-ethylene copolymer, and a polytetrafluoroethylene-vinylidene fluoride copolymer; and a composition of a polymer having ion conductivity of an alkali metal ion (especially lithium-ion). These may be used singly or in a combination of two or more kinds thereof. From the viewpoint of achievement of a higher density, use of polyvinylidene fluoride is preferable.

A content (namely, a contained amount) of a negative electrode binder with respect to the mass of the negative electrode material mixture may be in the following range. The lower limit of the range is preferably 0.1% by mass or more from the viewpoint of adequate binding of the negative electrode active material to obtain an adequate mechanical strength of a negative electrode to stabilize battery performances such as cycle performance, more preferably 0.5% by mass or more, and still more preferably 1% by mass or more. The upper limit is preferably 40% by mass or less from the viewpoint of improvement of battery capacity and electrical conductivity, more preferably 25% by mass or less, and still more preferably 15% by mass or less.

The content of the negative electrode binder with respect to a mass of a negative electrode material mixture is preferably from 0.1% by mass to 40% by mass, more preferably from 0.5% by mass to 25% by mass, and still more preferably from 1% by mass to 15% by mass.

As a solvent for dispersing the active material, conductive material and binder, an organic solvent such as N-methyl-2-pyrrolidone may be used.

A lithium-ion battery according to the embodiment may contain as constituents in addition to a positive electrode and a negative electrode also a separator provided between the positive electrode and the negative electrode, an electrolyte solution or the like identically with a common lithium-ion battery.

There is no particular restriction on a separator, insofar as it has ion permeability while insulating electronically a positive electrode from a negative electrode, and is resistant to oxidizing environment at a positive electrode and to reducing environment at a negative electrode. As a material for a separator satisfying such characteristics, a resin, an inorganic substance, glass fiber or the like may be used.

As a resin, an olefinic polymer, a fluorinated polymer, a cellulosic polymer, polyimide, nylon or the like are used. Specifically, it should be preferably selected from materials which are stable against an electrolyte solution and superior in solution retention, and use of a porous sheet, or a nonwoven fabric made from polyolefin as a source material, such as polyethylene and polypropylene, is preferable. Further, considering that the average electric potential of a positive electrode is as high as 4.7 V to 4.8 V with respect to Li/Li⁺, one having a three-layer structure of polypropylene/polyethylene/polypropylene, in which polyethylene is sandwiched by polypropylene superior in resistance to high electric voltage, is also preferable.

As an inorganic substance, an oxide such as alumina and silicon dioxide, a nitride such as aluminum nitride and silicon nitride, a sulfate such as barium sulfate and calcium sulfate, or the like are used. For example, a substrate in a thin film shape such as a nonwoven fabric, a woven fabric and a microporous film, to which the inorganic substance in a fiber shape or a particle shape is stuck, may be used as a separator. A substrate in a thin film shape with a pore diameter of from 0.01 μm to 1 μm and a thickness of from 5 μm to 50 μm may be used favorably. Further, a complex porous layer formed from the inorganic substance in a fiber shape or a particle shape using a binder such as a resin is used as a separator. Alternatively, the complex porous layer may be formed on a surface of a positive electrode or a negative electrode as a separator. For example, a complex porous layer may be formed on a surface of a positive electrode, or on a side of a separator facing a positive electrode by binding alumina particles with a 90% particle size of less than 1 μm using a fluorocarbon resin as a binder.

Further, a current collector is used in a positive electrode and a negative electrode. As for a material for a current collector, in the case of a current collector to be used in a positive electrode, in addition to aluminum, titanium, stainless steel, nickel, baked carbon, electrically conductive polymer, electrically conductive glass or the like, aluminum, copper, or the like, which surface is subjected to a treatment for sticking carbon, nickel, titanium, silver, or the like thereto for the purpose of improvement of adhesiveness, electrical conductivity, oxidation resistance or the like, may be used. As a current collector used in a negative electrode, in addition to copper, stainless steel, nickel, aluminum, titanium, sintered carbon, electrically conductive polymer, electrically conductive glass, an aluminum-cadmium alloy or the like, copper, aluminum or the like, which surface is subjected to a treatment for carbon, nickel, titanium, silver or the like thereto for improvement of adhesiveness, electrical conductivity, resistance to reduction or the like, may be used. In this regard, the thickness of a positive electrode current collector and a negative electrode current collector is preferably from 1 μm to 50 μm from the viewpoint of electrode strength and volumetric energy density.

An electrolyte solution according to the embodiment is preferably a nonaqueous electrolyte solution composed of a lithium salt (namely, electrolyte), and a nonaqueous solvent dissolving the same. If necessary, an additive may be added into an electrolyte solution.

Examples of a lithium salt include LiPF₆, LiBF₄, LiFSI (lithium bis(fluorosulfonyl)imide), LiTFSI (lithium bis(trifluoromethanesulfonyl)imide), LiClO₄, LiB (C₆H₅)₄, LiCH₃SO₃, LiCF₃SO₃, LiN(SO₂F)₂, LiN(SO₂CF₃)₂, and LiN(SO₂CF₂CF₃)₂. The lithium salts may be used singly or in a combination of two or more kinds thereof. Among them, lithium hexafluorophosphate (LiPF₆) is preferable judging by charge and discharge characteristics, output characteristic, cycle performance or the like in a comprehensive manner.

A concentration of the lithium salt is preferably from 0.5 mol/L to 1.5 mol/L with respect to a nonaqueous solvent, more preferably from 0.7 mol/L to 1.3 mol/L, and still more preferably from 0.8 mol/L to 1.2 mol/L. When the concentration of the lithium salt is from 0.5 mol/L to 1.5 mol/L, the charge and discharge characteristics may be improved further.

There is no particular restriction on a nonaqueous solvent, insofar as it is a nonaqueous solvent usable as a solvent for an electrolyte for a lithium-ion battery. Examples of a nonaqueous solvent include ethylene carbonate, propylene carbonate, dimethyl carbonate, diethyl carbonate, methyl ethyl carbonate, γ-butyrolactone, acetonitrile, 1,2-dimethoxyethane, dimethoxymethane, tetrahydrofuran, dioxolane, methylene chloride, and methyl acetate. The solvents may be used singly or in a combination of two or more kinds thereof, and use of a mixed solvent combining two or more kinds of compounds is preferable.

There is no particular restriction on an additive, insofar as it is an additive for a nonaqueous electrolyte solution of a lithium-ion battery. Examples of an additive include a heterocyclic compound including nitrogen, sulfur, or nitrogen and sulfur, a cyclic carboxylic acid ester, a fluorine-containing cyclic carbonate, and another compound having an unsaturated bond in the molecule. Further, in addition to the above additive, another additive, such as an overcharge prevention agent, a negative electrode film-form agent, a positive electrode protection agent, and a high input-output agent, may be used according to a required function.

There is no particular restriction on a content (namely, percentage) of the additive in an electrolyte solution, and its range is as follows. When the additive are used in any combination of two or more kinds thereof, a content refers to each additive. The lower limit of a content of the additive with respect to an electrolyte solution is preferably 0.01% by mass or more, more preferably 0.1% by mass or more, and still more preferably 0.2% by mass or more. The upper limit is preferably 5% by mass or less, more preferably 3% by mass or less, and still more preferably 2% by mass or less. The content of the additive in an electrolyte solution is preferably from 0.01% by mass to 5% by mass, more preferably from 0.1% by mass to 3% by mass, and still more preferably from 0.2% by mass to 2% by mass.

Improvement of capacity maintenance characteristic after storage at a high temperature, and cycle performance, improvement of input-output characteristics or the like may be achieved by the additive.

A lithium-ion battery constituted as above may take various shapes, such as cylindrical, layer-built, and coin-shaped. In any shape, a separator is inserted between a positive electrode and a negative electrode to form an electrode body. A positive electrode current collector and a negative electrode current collector are connected by collecting leads respectively with a positive electrode terminal and a negative electrode terminal, which connect with the outside, and the electrode body is packed together with an electrolyte solution in a battery case to be sealed.

As an example of the embodiment, a layer-built lithium-ion battery, in which a positive plate and a negative plate are laminated intercalating a separator, will be described, provided that an embodiment of the invention is not limited thereto. Other examples of embodiment include a wound type lithium-ion battery, in which a laminate formed by laminating a positive plate and a negative plate intercalating a separator is wound up spirally.

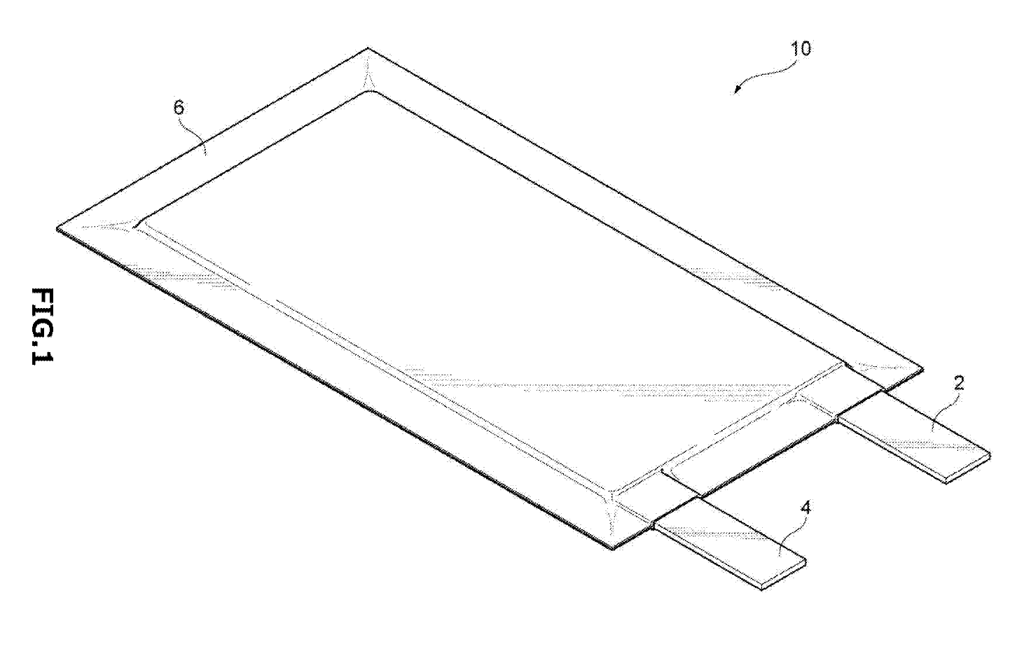

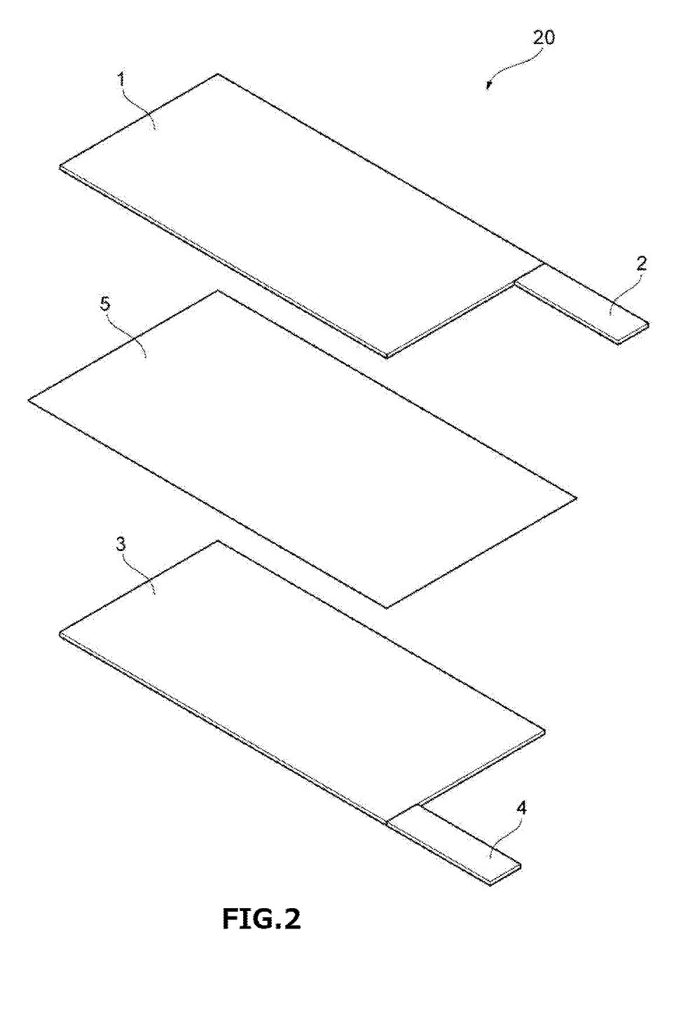

FIG. 1 is a perspective view showing an embodiment of a lithium-ion battery. FIG. 2 is a perspective view showing a positive plate, a negative plate, and a separator constituting an electrode assembly.

In this regard, elements that have substantially the same function are denoted with the same reference signs throughout the drawings, and repeated explanation is sometimes omitted.

In a lithium-ion battery 10 in FIG. 1, an electrode assembly 20 and an electrolyte solution for a lithium-ion battery are packed in a battery container made of a laminate film 6, and a positive electrode collector tab 2 and a negative electrode collector tab 4 are extracted out of the battery container.

An electrode assembly 20 packed in a battery container is formed as shown in FIG. 2 by laminating a positive plate 1 provided with a positive electrode collector tab 2, a separator 5, and a negative plate 3 provided with a negative electrode collector tab 4.

In this regard, the dimension, shape or the like of a positive plate, a negative plate, a separator, an electrode assembly, and a battery may be optional, and not limited to those shown in FIG. 1 and FIG. 2.

The density of a positive electrode material mixture of a lithium-ion battery to be used in the embodiment is from 2.5 g/cm³ to 3.2 g/cm³ from the viewpoint of volumetric energy density. When the density of a positive electrode material mixture is 2.5 g/cm³ or more, the thickness of a positive electrode material mixture becomes thin so as to enhance the volumetric energy density. Meanwhile, when the density of a positive electrode material mixture is 3.2 g/cm³ or less, wettability of an electrolyte solution with respect to a positive electrode material mixture is enhanced to improve input-output characteristics. The density of a positive electrode material mixture is preferably from 2.6 g/cm³ to 3.0 g/cm³.

In a lithium-ion battery to be used in the embodiment, the density of a negative electrode material mixture is, from the viewpoint of volumetric energy density, preferably from 1.0 g/cm³ to 2.7 g/cm³, more preferably from 1.5 g/cm³ to 2.4 g/cm³, and still more preferably from 1.7 g/cm³ to 2.2 g/cm³.

An embodiment of a lithium-ion battery according to the invention has been described herein above, however the embodiment is only an exemplary embodiment, and a lithium-ion battery according to the invention may be implemented in various modes including the embodiment as well as various modifications and improvements thereto devised based on knowledges of a person skilled in the art.

### EXAMPLES

The embodiment will be described in more details below by way of Examples, provided that the invention be not restricted in any way by the following Examples.

### Example 1

For a positive electrode, 93 parts by mass of a lithium nickel manganese complex oxide (LiNi_{0.5}Mn_{1.5}O₄), with a BET specific surface area of 0.1 m²/g, and an average particle diameter of 28.8 μm, 5 parts by mass of acetylene black (manufactured by Denka Company Limited) as a conductive material, 1.5 parts by mass of a copolymer which has a polyacrylonitrile structure added by acrylic acid and a straight chain ether group (trade name: LSR7, manufactured by Hitachi Chemical Co., Ltd., hereinafter referred to as “binder A”) as a positive electrode binder, and 0.5 part by mass of polyvinylidene fluoride (hereinafter referred to as “binder B”) were mixed, followed by addition of an an appropriate amount of N-methyl-2-pyrrolidone. The mixture was kneaded to obtain a pasty positive electrode material mixture slurry. The positive electrode material mixture slurry was coated substantially evenly and homogeneously on both sides of a 20 μm-thick aluminum foil, which is a current collector for a positive electrode, to a thickness of 140 g/m² to obtain a sheet-formed positive electrode. The sheet is then subjected to a drying treatment and compressed by a press until the density of the positive electrode material mixture reached 2.6 g/cm³. The pressed sheet was cut to 30 mm wide by 45 mm long to prepare a positive plate, to which a positive electrode collector tab was attached as shown in FIG. 2.

For a negative electrode, metal lithium (thickness 0.5 mm, manufactured by The Honjo Chemical Corporation) was cut to 31 mm wide by 46 mm long, and bonded to a copper mesh (manufactured by The Nilaco Corporation) fabricated to 31 mm wide by 46 mm long to prepare a negative plate, to which a negative electrode collector tab was attached as shown in FIG. 2.

(Production of Electrode Assembly)

The prepared positive plate and negative plate were so placed to face each other intercalating a separator made of polyethylene microporous film with a dimension of 30 μm thick by 35 mm wide by 50 mm long, thereby completing a layer-built electrode assembly.

(Production of Lithium-Ion Battery)

The electrode assembly was placed in a battery container composed of an aluminum laminate film as shown in FIG. 1, and 1 mL of a nonaqueous electrolyte solution was injected into the battery container. Then, the positive electrode collector tab and the negative electrode collector tab were pulled out and the opening of the battery container was sealed to produce a lithium-ion battery of Example 1. As the nonaqueous electrolyte solution, a mixed solvent of ethylene carbonate and dimethyl carbonate blended at a volume ratio of 3:7, to which LiPF₆ was dissolved at a concentration of 1M, was used. In this regard, the aluminum laminate film is a laminate of polyethylene terephthalate (namely, PET) film/aluminum foil/sealant layer (for example, polypropylene).

The lithium-ion battery was charged by constant-current charge at 25° C. with a current value of 0.2 C to a charge cut-off voltage of 4.95 V, and then by constant-voltage charge with a battery charge voltage of 4.95 V until the current value reached 0.01 C using a charge and discharge apparatus (trade name: BATTERY TEST UNIT, manufactured by IEM). In this regard, “C” used as a unit for a current value means “current (A)/battery capacity (Ah)”. After a pause of 15 min, constant current discharge was conducted with a current value of 0.2 C, and a discharge cut-off voltage of 3.5 V. Charge and discharge under the above-mentioned charging and discharging conditions was repeated three times.

(Input Characteristic)

Using the lithium-ion battery, for which the discharge capacity was measured, after a pause of 15 min after the discharge, constant-current charge was conducted at 25° C. with a current value of 0.5 C to a charge cut-off voltage of 4.95 V, and then constant-voltage charge was conducted with a charge cut-off voltage of 4.95 V until the current value reached 0.01 C. Then, a battery charge capacity was measured (namely, battery charge capacity at 0.5 C). After a pause of 15 min, constant current discharge was conducted at 25° C. with a current value of 0.5 C to a cut-off voltage of 3.5 V. Next, after a pause of 15 min, constant-current charge was conducted at 25° C. with a current value of 5 C to a charge cut-off voltage of 4.95 V, and a battery charge capacity was measured (namely, battery charge capacity at 5 C). Then, an input characteristic was calculated according to the following equation. The obtained result is shown in Table 1.

Input characteristic (%)=(battery charge capacity at 5 C/battery charge capacity at 0.5 C)×100

(Output Characteristic)

Using the lithium-ion battery, for which the input characteristic was measured, after a pause of 15 min after the charge, constant-current discharge was conducted at 25° C. with a current value of 0.5 C to a charge cut-off voltage of 3.5 V. After a pause of 15 min, constant-current charge was conducted at 25° C. with a current value of 0.5 C to a charge cut-off voltage of 4.95 V, and next constant-voltage charge was conducted with a charge cut-off voltage of 4.95 V until the current value reached 0.01 C. After a pause of 15 min, constant current discharge was conducted at 25° C. with a current value of 0.5 C to a cut-off voltage of 3.5 V, and a discharge capacity (namely, discharge capacity at 0.5 C) was measured. Next, after a pause of 15 min, constant-current charge was conducted at 25° C. with a current value of 0.5 C to a charge cut-off voltage of 4.95 V, then constant-voltage charge was conducted with a charge cut-off voltage of 4.95 V until the current value reached 0.01 C. After a pause of 15 min, constant current discharge was conducted at 25° C. with a current value of 5 C to a cut-off voltage of 3.5 V, and a discharge capacity (namely, discharge capacity at 5 C) was measured. Then, an output characteristic was calculated according to the following equation. The obtained result is shown in Table 1.

Output characteristic (%)=(discharge capacity at 5 C/discharge capacity at 0.5 C)×100

(Volumetric Energy Density)

A volumetric energy density was calculated by multiplying the discharge capacity of the lithium-ion battery at 0.5 C with a voltage of 4.75 V at a SOC (State of Charge) of 50%, followed by division by the volume of a positive electrode. Where, the volume of a positive electrode was calculated by multiplying a positive electrode area (30 mm wide by 45 mm long) with a positive electrode thickness which is a thickness of material mixture plus current collector. The obtained result is shown in Table 1.

In the present Example, a SOC of 100% means a state of full charge immediately after constant-voltage charge with a charge current of 0.02 C and a charge voltage of 4.95 V; and a SOC of 0% means a state of charge immediately after constant current discharge with a discharge current of 0.02 C and a cut-off voltage of 3.5 V.

Volumetric energy density(mWh/mm³)=(discharge capacity at 0.5C)×4.75V/(volume of positive electrode)

### Example 2

A lithium-ion battery was produced by the same manner as described in Example 1, except that as a binder in a positive electrode material mixture slurry, 1 part by mass of the binder A and 1 part by mass of the binder B were mixed as set forth at Example 2 in Table 1, and the input characteristic, output characteristic, and volumetric energy density were measured. The obtained results are shown in Table 1.

### Example 3

A lithium-ion battery was produced by the same manner as described in Example 1, except that as a binder in a positive electrode material mixture slurry, 0.5 part by mass of the binder A and 1.5 parts by mass of the binder B were mixed as set forth at Example 3 in Table 1, and the input characteristic, output characteristic, and volumetric energy density were measured. The obtained results are shown in Table 1.

### Example 4

A lithium-ion battery was produced by the same manner as described in Example 1, except that a sheet-formed positive electrode produced in Example 1 was subjected to a drying treatment, and compressed by a press such that the density of a positive electrode material mixture became 3.0 g/cm³ as set forth at Example 4 in Table 1, and the input characteristic, output characteristic, and volumetric energy density were measured. The obtained results are shown in Table 1.

### Example 5

A lithium-ion battery was produced by the same manner as described in Example 1, except that a sheet-formed positive electrode produced in Example 2 was subjected to a drying treatment, and compressed by a press such that the density of a positive electrode material mixture became 3.0 g/cm³ as set forth at Example 5 in Table 1, and the input characteristic, output characteristic, and volumetric energy density were measured. The obtained results are shown in Table 1.

### Example 6

A lithium-ion battery was produced by the same manner as described in Example 1, except that a sheet-formed positive electrode produced in Example 3 was subjected to a drying treatment, and compressed by a press such that the density of a positive electrode material mixture became 3.0 g/cm³ as set forth at Example 6 in Table 1, and the input characteristic, output characteristic, and volumetric energy density were measured. The obtained results are shown in Table 1.

### Comparative Example 1

A lithium-ion battery was produced by the same manner as described in Example 1, except that a sheet-formed positive electrode produced in Example 1 was subjected to a drying treatment, and compressed by a press such that the density of a positive electrode material mixture became 2.3 g/cm³ as set forth at Comparative Example 1 in Table 1, and the input characteristic, output characteristic, and volumetric energy density were measured. The obtained results are shown in Table 1.

### Comparative Example 2

A lithium-ion battery was produced by the same manner as described in Example 1, except that a sheet-formed positive electrode produced in Example 2 was subjected to a drying treatment, and compressed by a press such that the density of a positive electrode material mixture became 2.3 g/cm³ as set forth at Comparative Example 2 in Table 1, and the input characteristic, output characteristic, and volumetric energy density were measured. The obtained results are shown in Table 1.

### Comparative Example 3

A lithium-ion battery was produced by the same manner as described in Example 1, except that a sheet-formed positive electrode produced in Example 3 was subjected to a drying treatment, and compressed by a press such that the density of a positive electrode material mixture became 2.3 g/cm³ as set forth at Comparative Example 3 in Table 1, and the input characteristic, output characteristic, and volumetric energy density were measured. The obtained results are shown in Table 1.

### Comparative Example 4

A lithium-ion battery was produced by the same manner as in Comparative Example 1, except that as a binder in a positive electrode material mixture slurry, only a binder A in an amount of 2 parts by mass was mixed as set forth at Comparative Example 4 in Table 1, and the input characteristic, output characteristic, and volumetric energy density were measured. The obtained results are shown in Table 1.

### Comparative Example 5

A lithium-ion battery was produced by the same manner as described in Example 1, except that as a binder in a positive electrode material mixture slurry, only a binder B in an amount of 2 parts by mass was mixed as set forth at Comparative Example 5 in Table 1, and the input characteristic, output characteristic, and volumetric energy density were measured. The obtained results are shown in Table 1.

TABLE 1

| | | | | | Density | | | |
|---|---|---|---|---|---|---|---|---|
| | Positive | Positive | | | of | | | |
| | electrode | electrode | | | positive | | | |
| | active | conductive | Binder | Binder | electrode | | | Volumetric |
| | material | material | A | B | material | Input | Output | energy |
| | (% by | (% by | (% by | (% by | mixture | characteristic | characteristic | density |
| | mass) | mass) | mass) | mass) | (g/cm³) | (%) | (%) | (mWh/mm³) |
| Example 1 | 93 | 5 | 1.5 | 0.5 | 2.6 | 30 | 79 | 103 |
| Example 2 | 93 | 5 | 1.0 | 1.0 | 2.6 | 28 | 78 | 102 |
| Example 3 | 93 | 5 | 0.5 | 1.5 | 2.6 | 24 | 78 | 102 |
| Example 4 | 93 | 5 | 1.5 | 0.5 | 3.0 | 32 | 81 | 114 |
| Example 5 | 93 | 5 | 1.0 | 1.0 | 3.0 | 30 | 80 | 113 |
| Example 6 | 93 | 5 | 0.5 | 1.5 | 3.0 | 26 | 80 | 113 |
| Comparative | 93 | 5 | 1.5 | 0.5 | 2.3 | 12 | 77 | 94 |
| Example 1 | | | | | | | | |
| Comparative | 93 | 5 | 1.0 | 1.0 | 2.3 | 19 | 79 | 94 |
| Example 2 | | | | | | | | |
| Comparative | 93 | 5 | 0.5 | 1.5 | 2.3 | 12 | 76 | 93 |
| Example 3 | | | | | | | | |
| Comparative | 93 | 5 | 2.0 | 0.0 | 2.3 | 26 | 82 | 94 |
| Example 4 | | | | | | | | |
| Comparative | 93 | 5 | 0.0 | 2.0 | 2.6 | 1 | 22 | 98 |
| Example 5 | | | | | | | | |

It is clear through comparison of Examples 1 to 6 and Comparative Examples 1 to 3 in Table 1, that in a case where the density of a positive electrode material mixture is 2.5 g/cm³ or more, an input characteristic indicates a high value of 24% or more, however in a case where the density of a positive electrode material mixture is less than 2.5 g/cm³, an input characteristic indicates a low value of 19% or less.

It is clear through comparison of Examples 1 to 6 and Comparative Example 4 in Table 1, that in a case where both the binder A and the binder B are used as a positive electrode binder, an input characteristic indicates a high value of 24% or more, and further the density of a positive electrode material mixture indicates a high value of 2.5 g/cm³ or more. On the other hand, in a case where only the binder A is used as a positive electrode binder, it is clear that, although an input characteristic indicates a high value of 26%, the density of a positive electrode material mixture is less than 2.5 g/cm³.

Further, in Comparative Example 4, it is clear that, since the density of a positive electrode material mixture is less than 2.5 g/cm³, the thickness of a positive electrode material mixture becomes large, and the volumetric energy density is deteriorated.

It is clear through comparison of Examples 1 to 3 and Comparative Example 5 in Table 1, that in a case where both the binder A and the binder B are used as a positive electrode binder, an input characteristic indicates a high value of 24% or more, meanwhile in a case where only the binder A is used as a positive electrode binder, an input characteristic indicates a low value of 1%.

From the above results, it becomes clear that a battery superior in input characteristic can be obtained, insofar as a resin including a structural unit derived from a nitrile group-containing monomer as a positive electrode binder in a lithium-ion battery is included, and the density of the positive electrode material mixture is from 2.5 g/cm³ to 3.2 g/cm³.

The entire contents of the disclosures by Japanese Patent Application No. 2014-218156 are incorporated herein by reference. All the literature, patent application, and technical standards cited herein are also herein incorporated to the same extent as provided for specifically and severally with respect to an individual literature, patent application, and technical standard to the effect that the same should be so incorporated by reference.

1. A lithium-ion battery comprising:
a positive electrode,
a negative electrode, and
an electrolyte solution;
wherein the positive electrode comprises a current collector, and a positive electrode material mixture that is placed on at least one side of the current collector,
wherein the positive electrode material mixture comprises a positive electrode conductive material, a lithium nickel manganese complex oxide as a positive electrode active material, and a resin having a structural unit derived from a nitrile group-containing monomer as a positive electrode binder, and
wherein a density of the positive electrode material mixture is from 2.5 g/cm³ to 3.2 g/cm³.

2. The lithium-ion battery according to claim 1, wherein the negative electrode comprises a lithium titanium complex oxide as a negative electrode active material, and a negative electrode conductive material.

3. The lithium-ion battery according to claim 2, wherein the lithium titanium complex oxide has a spinel structure.

4. The lithium-ion battery according to claim 2, wherein a content of the lithium titanium complex oxide is from 70% by mass to 100% by mass with respect to a total amount of the negative electrode active material.

5. The lithium-ion battery according to claim 2, wherein the negative electrode conductive material comprises acetylene black.

6. The lithium-ion battery according to claim 1, wherein the lithium nickel manganese complex oxide has a spinel structure.

7. The lithium-ion battery according to claim 6, wherein the lithium nickel manganese complex oxide having a spinel structure is a compound represented by LiNiₓMn₂₋ₓO₄ (0.3<X<0.7).

8. The lithium-ion battery according to claim 1, wherein the electric potential of the lithium nickel manganese complex oxide in a charged state is from 4.5 V to 5 V with respect to Li/Li⁺.

9. The lithium-ion battery according to claim 1, wherein a BET specific surface area of the lithium nickel manganese complex oxide is less than 2.9 m²/g.

10. The lithium-ion battery according to claim 1, wherein a content of the lithium nickel manganese complex oxide is from 60% by mass to 100% by mass with respect to a total amount of the positive electrode active material.

11. The lithium-ion battery according to claim 1, wherein the positive electrode conductive material comprises acetylene black.

12. The lithium-ion battery according to claim 1, wherein the positive electrode binder further comprises at least one selected from the group consisting of a structural unit derived from a monomer represented by the Formula (I), and a structural unit derived from a monomer represented by the Formula (II), 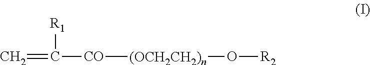
wherein, in Formula (I), R₁ is H or CH₃, R₂ is H or a monovalent hydrocarbon group, and n is an integer of from 1 to 50, 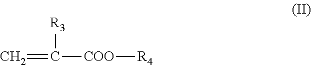
and wherein, in Formula (II), R₃ is H or CH₃, and R₄ is H or an alkyl group having from 4 to 100 carbon atoms.

13. The lithium-ion battery according to claim 1, wherein the positive electrode binder further comprises a structural unit derived from a carboxyl group-containing monomer.

14. The lithium-ion battery according to claim 1, wherein the electrolyte solution comprises an electrolyte and a nonaqueous solvent that dissolves the electrolyte, and the electrolyte comprises lithium hexafluorophosphate.
